(19) United States
(12) Patent Application Publication
(10) Pub. No.: US 2011/0002143 A1
(43) Pub. Date: Jan. 6, 2011

(54) LIGHT GUIDE PLATE AND A METHOD OF MANUFACTURING THEREOF

(75) Inventors: Pasi Saarikko, Espoo (FI); Pauli Laitinen, Helsinki (FI); Mika Kauhanen, Espoo (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/521,623

(22) PCT Filed: Dec. 28, 2006
(86) PCT No.: PCT/FI2006/050591

§ 371 Date: Aug. 26, 2010

(51) Int. Cl. F21V 7/22; G02B 6/34; B26D 7/00

(52) U.S. Cl. 362/611; 385/36; 83/23

(57) ABSTRACT

A light guide plate (100) has an input face (11) to couple light (B0) emitted by a light source (50) into said light guide (100), and an out-coupling grating (30) to couple light (B2) out of said light guide (100). Said out-coupling grating (30) is substantially perpendicular to said input face (11). A rough cut side of a light guide (100) is processed by a heated surface processing member (701) to smooth out irregularities and/or to implement a further diffraction grating (12) on said input face (11). The efficiency of coupling light out of the light guide (100) may be substantially increased and/or stray light effects may be reduced.

### FIELD OF THE INVENTION

The present invention relates to light guides, and to methods for making light guides.

### BACKGROUND OF THE INVENTION

Planar waveguides are cost-effective devices to provide lighting for e.g. liquid crystal displays or key sets. Light initially provided e.g. by an a light emitting diode (LED) may be distributed to a larger area by means of a planar waveguide. The use of thin planar waveguides may facilitate reducing size, weight and manufacturing costs of a portable device.

US patent application US2006/0002675 discloses a light guide plate comprising an upper cladding film, core films formed with V-cut grooves, and a lower cladding film. The V-cut grooves may be formed by means of a hot embossing process. Referring to FIG. 10 of US2006/0002675, light incident on the side surface of the light guide plate propagates in the core films, and is subsequently vertically reflected from the V-cut grooves.

### SUMMARY OF THE INVENTION

The object of the invention is to provide a light distributing device. A further object of the invention is to provide a method of manufacturing a light distributing device.

According to a first aspect of the invention, there is provided a manufacturing method according to claim 1.

According to a second aspect of the invention, there is provided a method of distributing light according to claim 9.

According to a third aspect of the invention, there is provided a light distributing device according to claim 11.

According to a fourth aspect of the invention, there is provided a device according to claim 14, said device comprising a key set.

According to a fifth aspect of the invention, there is provided a light distributing device according to claim 15.

According to a sixth aspect of the invention, there is provided a means for distributing light according to claim 16.

The light distributing device comprises a substantially planar waveguide having an out-coupling grating and a smoothed or embossed input face, wherein said input face is substantially perpendicular to said out-coupling grating.

Manufacturing of a planar light guide by die-cutting from a plastic sheet or carrier typically results in an optically diffusing side face. A die-cut side face of a light guide is processed using a hot surface processing tool. The surface of the side face may be polished by using a polished surface processing member, or the surface of the side face may be embossed using a member which has a microstructure.

A light beam emitted by a light source is coupled into the light guide through the side face to form a second light beam which is waveguided in the light guide by total internal reflections. The second light beam is subsequently coupled out of the light guide by an out-coupling grating in order to illuminate e.g. a liquid crystal display or a keypad.

According to the invention, topological errors of the input face may be reduced and/or completely eliminated. By removing topological errors, e.g. defects, the efficiency of coupling light of the light source into the light guide may be increased. Adverse stray light may be reduced by eliminating light-scattering defects.

Efficiency of coupling light out of a light guide by binary gratings typically degrades at large angles of incidence. The angle of incidence at the out-coupling grating may be reduced by implementing refractive and/or diffractive structures on the input face. The reduction in the angle of incidence may lead to increased efficiency of coupling light out of the light guide.

The throughput efficiency may be increased by adding diffractive or refractive structures to the input face of the light guide. The input grating or prisms may change the direction of light rays which would otherwise propagate substantially straight through the light guide without impinging on the out-coupling grating. Thus, the diffractive or refractive structures may reduce or completely eliminate the portion of the light which would propagate substantially straight through the light guide without impinging on the out-coupling grating. The throughput efficiency means the ratio of optical output power coupled out by the out-coupling grating to the optical power of a light beam impinging on the input face.

Also the number of interactions between an in-coupled light beam and the out-coupling grating may be increased by diffractive or refractive structures implemented on the input face. The increased number of interactions may also lead to an improved throughput efficiency.

In an embodiment, a substantially collimated output beam may be provided when using a substantially collimated light source.

In an embodiment, a thin illuminated keypad and/or a thin illuminated display may be implemented.

The embodiments of the invention and their benefits will become more apparent to a person skilled in the art through the description and examples given herein below, and also through the appended claims.

### BRIEF DESCRIPTION OF THE DRAWINGS

In the following examples, the embodiments of the invention will be described in more detail with reference to the appended drawings in which

FIG. 1 shows, in a three dimensional view, a light guide and a light source adapted to provide back-lighting for a display,

FIG. 2a shows, in a three dimensional view, a substrate sheet comprising a plurality of out-coupling gratings,

FIG. 2b shows, in a side view, cutting of the input face of a light guide,

FIG. 2c shows, in a three dimensional view, a rough surface of the die-cut side face,

FIG. 3a shows, in a three dimensional view, surface processing of the cut side face,

FIG. 3b shows, in a side view, surface processing of the cut side face,

FIG. 3c shows, in a side view, a light guide having a diffractive grating on its input face, and a corresponding embossing surface processing member,

FIG. 3d shows a light guide having refractive prisms on its input face, and a corresponding embossing surface processing member,

FIG. 4 shows, in a side view, the grating period and the grating height of the in-coupling grating,

FIG. 5 shows, in a side view, light rays emitted from a light source,

FIG. 6 shows propagation of light in the light guide when the input face has a smooth and flat surface,

FIG. 7a shows, in a side view, propagation of light in the light guide when the input face has an in-coupling grating,

FIG. 7b shows propagation of light in the light guide when the input face has an in-coupling grating to diffract light into two different directions.

FIG. 7c shows, in a side view, propagation of light in the light guide when the input face comprises prisms,

FIG. 8a shows angular distribution of the intensity of light emitted by a substantially collimated light source,

FIG. 8b shows angular distribution of the intensity of light impinging on the out-coupling grating when light is provided by the light source of FIG. 8a and the input face does not comprise a grating structure.

FIG. 8c shows angular distribution of the intensity of light impinging on the out-coupling grating when light is provided by the light source of FIG. 8a and the input face comprises a grating structure.

FIG. 9a shows angular distribution of the intensity of light emitted by a slightly collimated light source,

FIG. 9b shows angular distribution of the intensity of light impinging on the out-coupling grating when light is provided by the light source of FIG. 9a and the input face does not comprise a grating structure.

FIG. 9c shows angular distribution of the intensity of light impinging on the out-coupling grating when light is provided by the light source of FIG. 9a and the input face comprises a grating structure.

FIG. 10 shows, in a top view, an in-coupling grating adapted to collimate light in the horizontal direction,

FIG. 11a shows, in an end view, an input grating 12 which comprises vertical diffractive ridges to collimate light of the in-coupled beam in the horizontal direction,

FIG. 11b shows, in an end view, a crossed grating adapted to collimate light of the in-coupled beam in the horizontal direction and adapted to change the direction of the in-coupled beam in the vertical direction,

FIG. 11c shows, in a three dimensional view, a portion of the surface of a crossed grating,

FIG. 12 shows, in a three dimensional view, a surface processing roll,

FIG. 13 shows, in a three dimensional view, a portable device having a display and a key set, wherein said display and said key set are illuminated using light guides, and

FIG. 14 shows, in a three dimensional view, a portable device having a key set, wherein the switches of said key set are located under a light guide.

### DETAILED DESCRIPTION

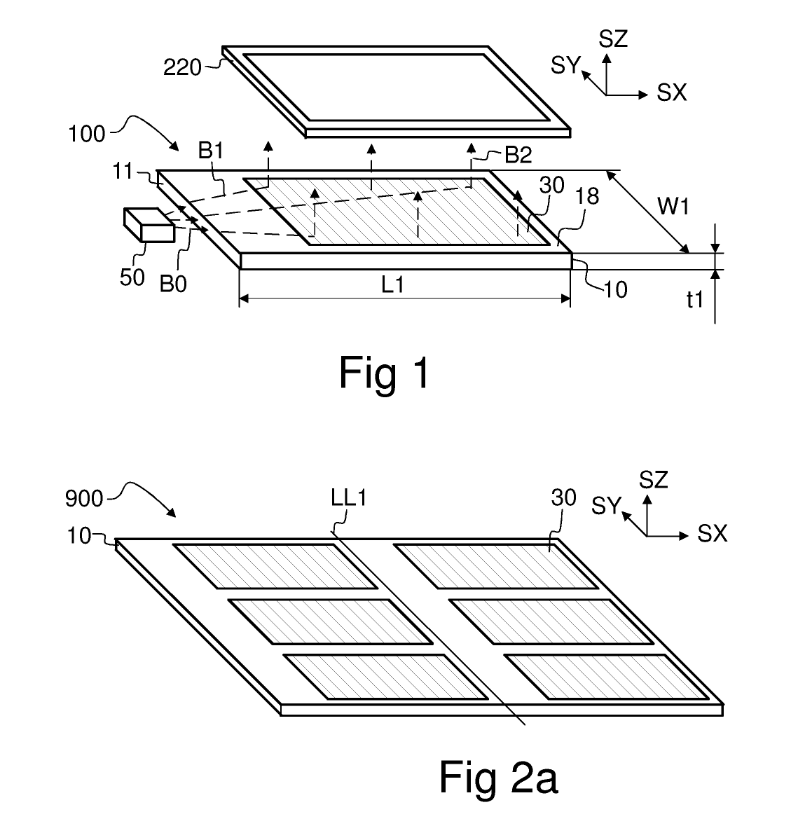

Referring to FIG. 1, a light guide 100 may comprise a substantially transparent substrate 10, a substantially planar input face 11 and a substantially planar surface 18. The light guide 100 may comprise two substantially planar and substantially parallel surfaces to implement a planar waveguide. The light guide 100 may comprise a diffractive out-coupling grating 30 implemented on the planar surface 18.

An input beam B0 provided by a light source 50 may be coupled into the substrate 10 through the input face 11 to form an in-coupled light beam B1 propagating in said substrate 10. The light of said in-coupled beam B1 may be coupled out of the substrate 10 by the diffractive out-coupling grating 30 to form an output beam B2. The output beam B2 may be used e.g. to light a display 220. The output beam B2 may be viewed e.g. by a human viewer (not shown).

The input beam B0 may be provided by a light source 50 which may be e.g. a light emitting diode (LED), a resonant cavity LED, or a laser. The light source 50 may be in contact with the input face 11 or at some distance from it.

The direction SX refers to the initial average direction of the input beam B0. If the beam B0 is symmetric, the direction SX is parallel to the centerline of the beam B0. The out-coupling grating 30 is in a horizontal plane defined by the directions SX and SY. The horizontal direction SY is perpendicular to the direction SX. The vertical direction SZ is perpendicular to the directions SX and SY.

The input face 11 may be substantially perpendicular to said out-coupling grating 30.

The ratio of the length L1 of the light guide 100 to the thickness t1 of the light guide 100 may be greater than 10. The ratio of the width W1 of the light guide 100 to the thickness t1 of the light guide 100 may be greater than 10. The thickness t1 of the planar waveguide may be e.g. in the range of 0.2 to 1 mm. In order to implement light and/or flexible structures, the thickness t1 may be in the range of 0.1 to 0.2 mm. In order to implement very light and/or flexible structures, the thickness t1 may be in the range of 0.05 to 0.1 mm.

In order to implement e.g. light distributing device 100 to illuminate a key set and/or display (FIG. 13), the width w1 and/or the length L1 of the planar waveguide may be e.g. in the range of 5 to 100 mm. The light guide 100 may comprise one or more out-coupling gratings 30. The sum of the areas of the out-coupling gratings 30 may be e.g. greater than 5% of the one-sided area of the planar surface 18.

A waveguiding core of the light guide 100, and in particular one or more of its planar surfaces may be covered by a cladding layer which has lower refractive index than said core. The cladding may comprise e.g. fluoropolymer, in particular polytetrafluoroethylene.

The dimensions t1, W1, and L1 refer to the dimensions of the waveguiding core of the planar waveguide 100, i.e. a possible cladding layer is not taken into consideration.

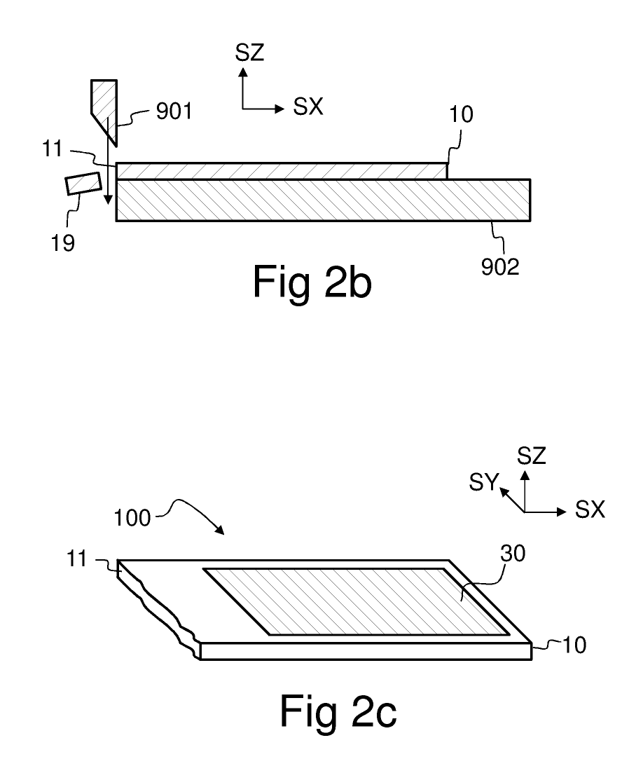

Referring to FIG. 2a, the light guide 100 may be manufactured by implementing a plurality of out-coupling gratings 30 on a substrate sheet 900, and cutting the light guide 100 apart. In particular, the input face 11 may be produced by cutting along a line LL1 shown in FIG. 2a.

The out-coupling gratings 30 may be implemented before said cutting, substantially simultaneously with said cutting, or after said cutting. The out-coupling gratings 30 may be implemented e.g. by embossing.

The material of the sheet 900 may be substantially transparent thermoplastic polymer, e.g. polycarbonate, polymethylmetacrylate (PMMA) or polyvinyl chloride.

Referring to FIG. 2b, the input face 11 may be cut using a cutting edge 901 and a counterpart 902. The cutting edge 901 may be moved in a opposite to the direction SZ with respect to the counterpart 902 in order to separate a piece 19. The cutting edge 901 may also be a rotating cutting disc. The piece 19 may be another light guide 100 or a waste cutting.

Referring to FIG. 2c, the cutting process may result in surfaces which are relatively rough when compared to the wavelengths of guided light. A rough input face 11 may refract and scatter the light of the in-coupled light beam B1 such that harmful stray light effects may arise and/or the efficiency of coupling light from the input face 11 to the out-coupling grating 30 is decreased.

The rough surfaces cause scattering of light into unwanted directions, i.e. stray light. The input face 11 may comprise defects, i.e. light-scattering protrusions and/or recesses. The criterion for a defect may be e.g. that a defect causes greater than λ/4 distortion in a planar wavefront of light transmitted through the input face 11. The wavelength λ may be e.g. 550 nm, which corresponds to the green color.

The wavefront distortion depends on the height of a defect and the refractive index difference over the input face 11. The refractive index of polycarbonate is approximately 1.6, and the refractive index of polymethylmetacrylate is approximately 1.5. The respective refractive index difference for an air-substrate interface may be e.g. 0.5 to 0.6. Thus, a protrusion of 0.25 μm may cause a 125 to 150 nm retardation in a wavefront transmitted through the input face 11. The retardation of 125 nm corresponds approximately to λ/4 for the wavelength 550 nm.

For demanding applications, the criterion for a defect may also be defined such that it causes less than λ/10 distortion in the wavefront, and/or that the defect protrudes more than λ/10 μm from the average level of the input face 11, wherein the wavelength λ may be e.g. 550 nm.

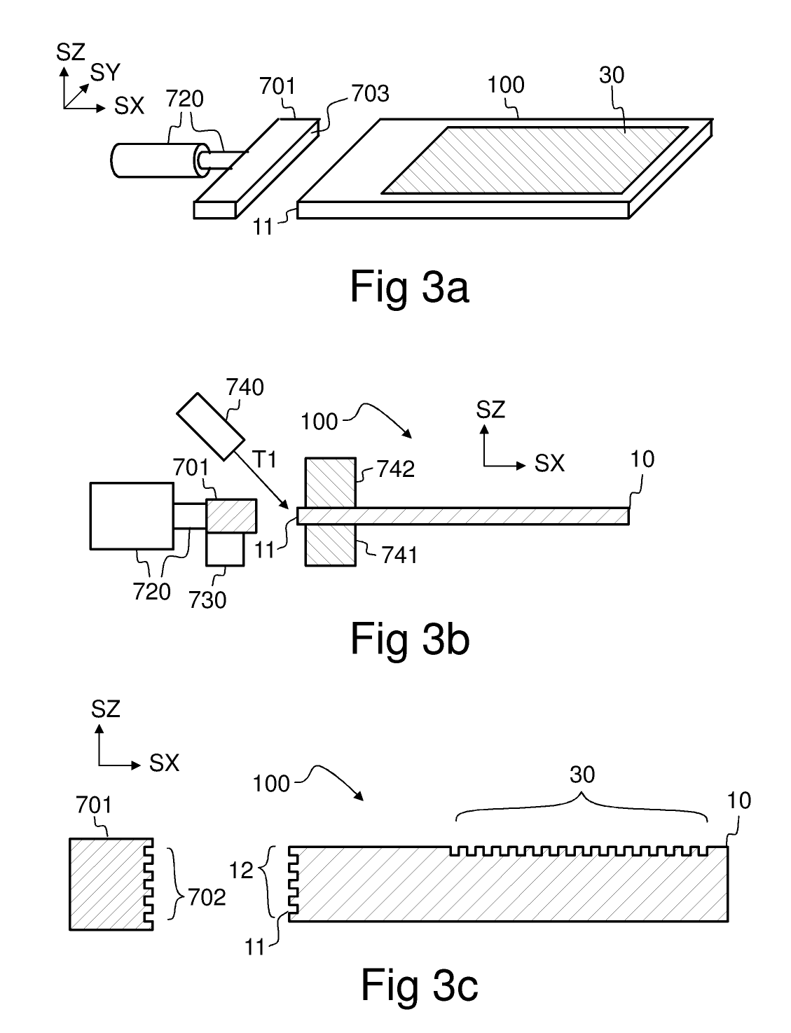

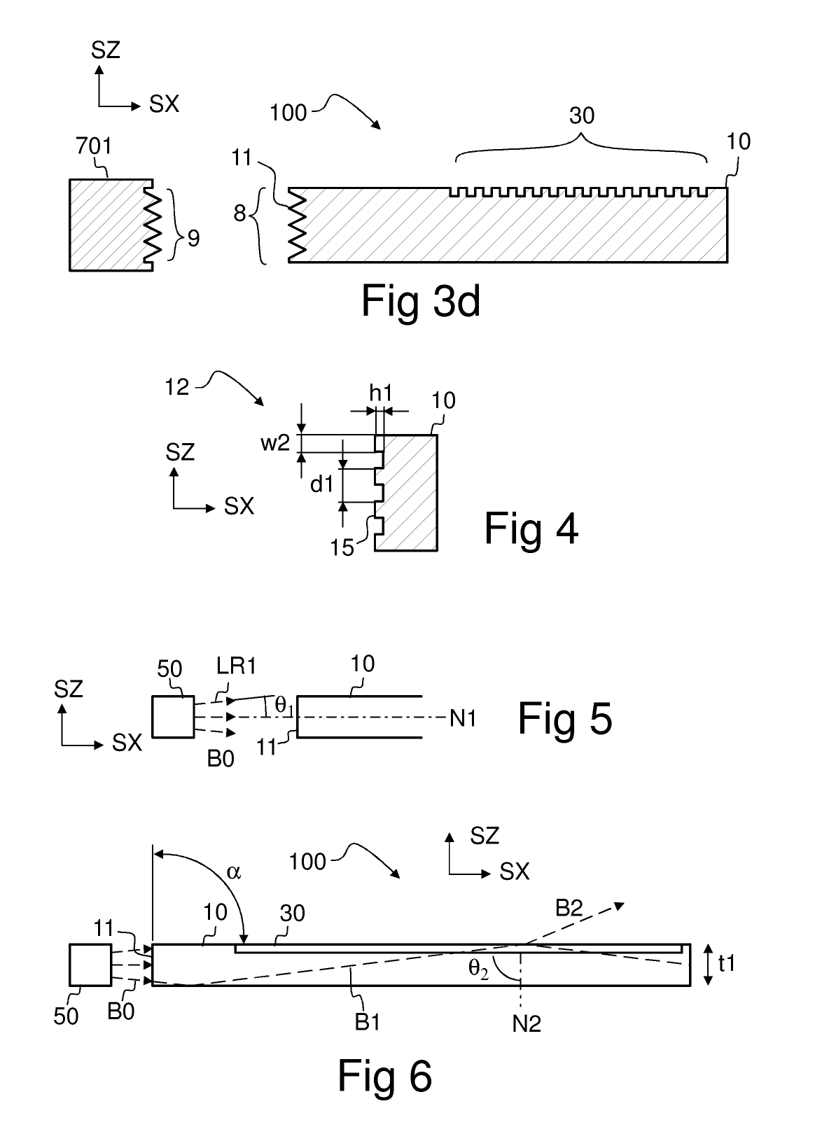

Referring to FIG. 3a, a rough input face 11 may be processed by pressing a surface processing member 701 against the face 11. Pressing by the surface processing member 701 may smooth out irregularities and/or may implement a diffraction grating on the input face 11.

The member 701 may have e.g. a substantially flat polished surface 703 to smooth the surface of the input face 11.

The smoothed input face 11 may polished, i.e. it may be substantially non-diffusing. The smoothing may reduce the number and the size of light scattering defects such that they cover less than 5%, or even less than 1% of the area of the input face 11.

Referring to FIG. 3b, the surface processing member 701 may be pressed against the input face 11 by an actuator 720 or spring mechanism in the direction SX with respect to the substrate 10. The substrate 10 may be clamped between a first clamping block 741 and a second clamping block 742 to keep it fixed. The actuator 720 may be e.g. a pneumatic, hydraulic or electromechanic actuator

The surface of the input face 11 may be softened by heating in order to facilitate smoothing and/or embossing. The surface layer of the input face 11 may be kept at an elevated temperature, e.g. at a temperature greater than 150° C. during the processing in order to facilitate the processing. The material of the substrate 10 may have a softening temperature, which is also known as the glass transition temperature T_{G}. For example, the glass transition temperature of polycarbonate is typically in the range of 145 to 150° C., and the glass transition temperature of polymethylmetacrylate is approximately 105° C. During the embossing or smoothing process, the temperature Tₛ of the surface of the input face 11 should reach at least temporarily a maximum temperature which is greater than T_{G}.

A first heater 730 may be adapted to heat the surface processing member 701. The heater 730 may be e.g. an electrical heating element or a heat exchanger for transferring heat from hot fluid to the member 701. A second heater 740 may be adapted to heat the input face 11 prior to the processing and/or during the processing. The heater 740 may be based e.g. on infrared radiation or hot gas flow.

The surface processing member 701 may exert an embossing pressure on the input face 11. The embossing pressure may be substantially equal to a predetermined value.

The maximum temperature Tₛ of the input face 11 may be kept lower than a predetermined upper limit in order to avoid boiling of the substrate material, in order to avoid irreversible chemical damage of the substrate material, in order to minimize sticking of the substrate material to the surface processing member 701, and/or in order to avoid excessive deformation of the input face 11 due to pressure caused by the surface processing member 701 or deformation due to gravity. An excessive deformation may lead e.g. to a local increase in the thickness t1 and width W1 near the input face 11 during the pressing.

During the embossing or smoothing process, the temperature Tₛ of the surface of the input face 11 may reach at least temporarily a maximum temperature, which is e.g. in the range of T_{G} to T_{G}+30° C., in the range of T_{G}+30° C. to T_{G}+70° C., in the range of T_{G}+70° C. to T_{G}+100° C., or even in the range of T_{G}+100° C. to T_{G}+170° C. The use of high temperatures may facilitate implementing of fine microstructures, but may also require fast heating and cooling of the input face 11 so that only a thin surface layer is deformed during the processing. The maximum temperature Tₛ of the input face 11 may be selected to correspond to a predetermined embossing pressure.

The temperature of the surface processing member 701 may be kept below a predetermined temperature in order to minimize sticking of the substrate material to the member 701 and/or in order to minimize deformation of an embossed structure when the member 701 is separated from the input face 11. However, the temperature of the surface processing member 701 should not be so low as to harden the input face 11 before the embossing is completed. During the processing, the temperature of the surface processing member 701 may be lower than the glass transition temperature T_{G}, and/or the temperature of the surface processing member 701 may be e.g. 20° C. to 50° C., 50° C. to 100° C., or even 100° C. to 200° C. lower than the maximum temperature of the input face 11.

In particular, the temperature of the surface processing member 701 may be kept 10 to 30° C. lower than a self-adhesive temperature of the substrate material in order to minimize sticking. The self-adhesive temperature is defined as the minimum temperature at which two layers of said substrate material will mutually adhere when pressed together without using any release agents. The surface processing member 701 may be coated with e.g. fluoropolymer-based release agent before the processing in order to minimize sticking.

Referring to FIG. 3c, the surface processing member 701 may also comprise a grating structure 702 to emboss an in-coupling grating structure 12 to the input face 11. The surface processing member 701 has a surface relief which corresponds to the surface relief of the in-coupling grating 12.

The grating structure 702 may be implemented e.g. on a nickel shim by optical methods, electrolytic methods and/or electron beam lithography.

Referring to FIG. 3d, the surface processing member 701 may have a macroscopic pattern 9 in order to emboss a macroscopic structure 8 to the surface of the input face 11. The macroscopic structure may comprise e.g. one or more prisms.

Referring to FIG. 4, the in-coupling grating 12 may have a grating period d1. The embossed diffractive features 15 may have a height h1. For visible light, d1 may be e.g. in the range of 0.2 to 2 μm. The height h1 may be e.g. 0.25 to 4 times a wavelength of visible light.

A filling factor f is the ratio of the width w2 of the diffractive features 15 compared to the grating period d1. The filling factor of the gratings 12, may be e.g. in the range of 40% to 60%.

A gap between the light source 50 and the in-coupling grating 12 may be filled with a transparent filler, e.g. adhesive. In that case the grating period d1 and the profile height h1 of the in-coupling grating 12 may be selected to be e.g. substantially equal to 2 μm.

The grating period of the surface processing member 701 is selected to be substantially equal to d1. The height of the embossing microstructure of the member 701 is selected to be equal to or greater than h1.

Referring to FIG. 5, the light source 50 provides an input light beam B0. The light source 50 may comprise e.g. a light emitting diode (LED) and a collimating structure, e.g. a convex lens. The intensity I(θ₁) of the input beam B0 may depend on the angle θ₁, where the angle θ₁ is a vertical angle between the direction of a light ray LR1 and the surface normal N1 of the input face 11. The angular dependency of the intensity I(θ₁) may be expressed e.g. by the equation (1):

I(θ₁)=I₀ cosⁿ(θ₁) (1)

Where I₀ is the intensity in the direction SX, and cosₙ denotes cosine to the power of n.

The beam B0 provided by the light source 50 may be substantially collimated in the vertical and/or horizontal directions. The vertical divergence and/or the horizontal divergence may be in the range of 0 to 5 degrees, or in the range or 5 to 20 degrees. The beam B0 may be slightly collimated in the vertical and/or horizontal directions, i.e. the vertical divergence and/or the horizontal divergence may be in the range of 20 to 60 degrees. The beam B0 may be highly diverging, and the vertical divergence and/or the horizontal divergence may even be in the range of 60 to 180 degrees.

Referring to FIG. 6, the input beam B0 provided by the light source 50 may be substantially collimated and the input face 11 may be flat and optically smooth. Consequently, the in-coupled beam B1 is also substantially collimated and it impinges, in average, on the out-coupling grating 30 at a large angle θ₂. The angle θ₂ is an angle between a light ray and a surface normal N2 of the out-coupling grating 30. Consequently, the in-coupled beam B1 interacts only few times with the out-coupling grating 30, and the efficiency of coupling light out of the substrate 10 may be low. It may be that some light rays of the in-coupled beam B1 do not impinge on the out-coupling grating 30 at all, even if they were reflected from the lower planar surface of the light guide 100.

The embodiment of FIG. 6, i.e. without the in-coupling grating 12, may be used e.g. when the out-coupling grating 30 is long when compared to the thickness t1 of the substrate 10.

The angle α between the input face 11 and the out-coupling grating 30 may be in the range of 80 to 100 degrees. In particular, the angle α may be substantially equal to 90 degrees.

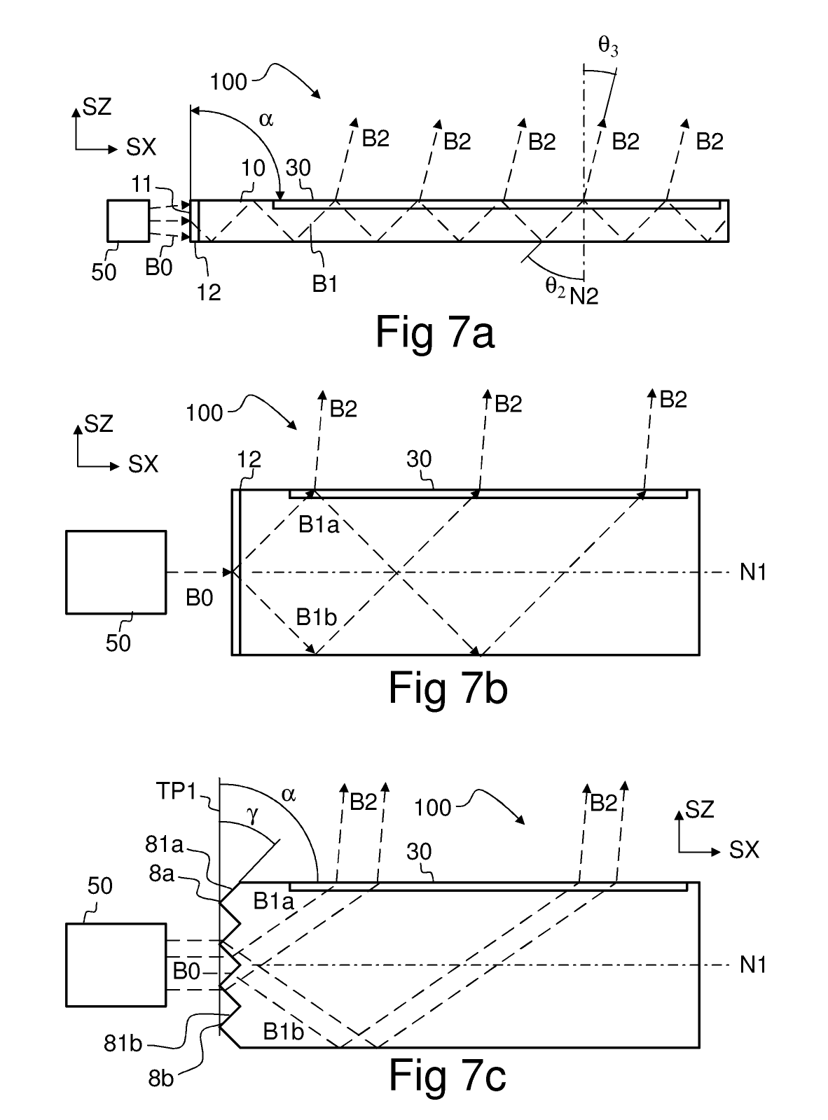

Referring to FIG. 7a, The direction of the beam B1 may be changed by coupling the input beam B0 into the substrate 10 through an in-coupling grating 12 implemented on the input face 11. Consequently, the in-coupled beam B0 may impinge, in average, on the out-coupling grating 30 at an angle θ₂, which is substantially smaller than in the case of FIG. 6. The in-coupled beam B1 also interacts more times with the out-coupling grating 30 than in the case of FIG. 6. The number of interactions between the light beam B1 and the out-coupling grating 30 is inversely proportional to tan(θ₂).

The efficiency of coupling light out of the substrate 10 may be substantially greater than in case of FIG. 6.

The local coupling efficiency at the left side of the out-coupling grating 30, i.e. near the input face 11 may be maximized by minimizing the angle θ₂ of the in-coupled beam B1 but keeping the angle θ₂ greater than a predetermined limit in order to fulfill the criterion for total internal reflection. The angle θ₂ may be selected e.g. such that no more than 5% of optical power is coupled out of the lower planar surface of the light guide 100. The local coupling efficiency is defined to be the ratio of the intensity of the output beam B2 to the intensity of the in-coupled beam B1 at a given point of the out-coupling grating 30.

In order to facilitate coupling of light out of the light guide 100, the angle θ₂ for the average direction of the in-coupled beam B1 may be selected to be greater than three times arctan(t1/L1)

The angle θ₃ between the average direction of the output beam B2 and the surface normal N2 of the out-coupling grating 30 may be e.g. in the range of 0 to 20 degrees. The output beam B2 may be substantially perpendicular to the out-coupling grating 30. The out-coupling grating 30 may be substantially planar.

The angle α between the input face 11 and the out-coupling grating 30 may be in the range of 80 to 100 degrees. In particular, the angle α may be substantially equal to 90 degrees.

Referring to FIG. 7b, the in-coupling grating 12 may be adapted to diffract light into one or more diffraction orders other than zero, e.g. into the diffraction orders minus one and one, in order to increase the number of interactions with the out-coupling grating 30 and/or in order to decrease the angle of incidence θ₂. The in-coupling grating 12 may be adapted to diffract at least 30% of the optical power of the input beam B0 into the diffraction order −1 or 1.

Referring to FIG. 7c, the input face 11 may comprise one or more prisms 8a, 8b to direct the in-coupled beam B1a and/or B1b away from the direction of the surface normal N1, in order to increase the number of interactions with the out-coupling grating 30 and/or in order to decrease the angle of incidence θ₂. In particular, the input face may comprise two or more prisms 8a, 8b. Increasing the number of the prisms may allow reducing the height of said prisms in the direction SX. Consequently, the light guide 100 may be shorter.

When the input face 11 comprises macroscopic prisms 8a, 8b, the surface normal N1 refers to the surface normal of a tangential plane TP1 of the input face 11. The angle α between the normal N1 input face 11 and the normal N2 of the out-coupling grating 30 may be in the range of 80 to 100 degrees. In particular, the angle α may be substantially equal to 90 degrees.

The angle α between the input face 11 and the out-coupling grating 30 may be in the range of 80 to 100 degrees. In particular, the angle α may be substantially equal to 90 degrees.

The prisms 8a, 8b are macroscopic refractive triangular features which have at least one face 81a, 81b which is inclined with respect to the tangential plane TP1 of the input face 11 in order to re-direct the in-coupled light beams B1a, B1b. An angle γ between the faces 81a, 81b of the prisms 8a, 8b and the tangential plane TP1 may be e.g. in the range of 10 to 60 degrees.

Referring back to FIGS. 7a and 7c, the fraction of light transmitted substantially in the direction of the surface normal N1 may be reduced. Thus, the fraction of light which would otherwise be transmitted substantially in the direction of the normal N1 through the substrate 10 may also be coupled out of the substrate 10.

The input beam B0 emitted from the light source 50 may have a predetermined vertical divergence in the direction SZ. When the light of said beam B0 is coupled out by the out-coupling grating 30, the output beam B2 may have substantially the same divergence in the direction SX. In other words, The output beam B2 may have substantially the same divergence as the input beam B0.

Embossing of the in-coupling grating 12 may require smaller deformation of the input face 11 than embossing of the prisms 8.

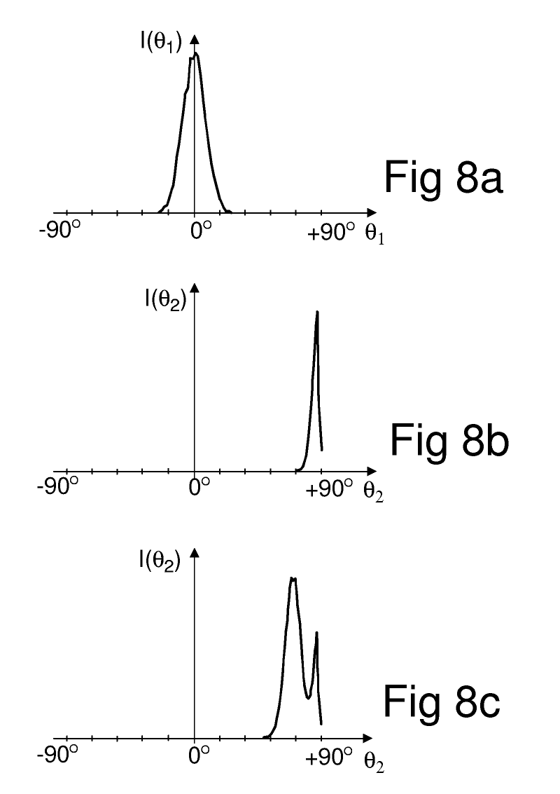

FIG. 8a shows the angular distribution of intensity I(θ₁) of a substantially collimated input beam B0 emitted by a light source 50.

Referring to FIG. 8b, it is assumed that the beam of FIG. 8a is coupled into a substrate through a smooth input face 11, as shown e.g. in FIG. 6. The input face 11 represents an air-polycarbonate interface, the angular intensity distribution of the beam B0 is expressed by eq. (1) having n=50, and the wavelength is 630 nm. FIG. 8b shows the angular intensity distribution of light B1 impinging on the out-coupling grating 30. It may be noticed that the peak of the angular intensity distribution is approximately at an angle θ₂ of 85 degrees. The position of the peak depends slightly on the ratio of the length of the out-coupling grating 30 to the thickness of the substrate 10.

Referring to FIG. 8c, it is assumed that the beam of FIG. 8a is coupled into a substrate through a binary input grating 12 having a period d1 of 0.7 μm, a filling factor of 0.5, and a profile height h1 of 0.4 μm. The input face 11 represents an air-polycarbonate interface, the angular intensity distribution of the beam B0 is expressed by eq. (1) having n=50, and the wavelength is 630 nm. FIG. 8c shows the angular intensity distribution of light B1 impinging on the out-coupling grating 30. It may be noticed that the peak of the angular intensity distribution is approximately at an angle θ₂ of 69 degrees.

The diffraction efficiency of a typical binary grating is rather low at large angles of incidence. Thus, light may be coupled out of the substrate 10 substantially more effectively in case of FIG. 8c than in case of FIG. 8b. In case of FIG. 8c, the efficiency of out-coupling by a binary out-coupling grating 30 is 5.5% for TE-polarization in the diffraction order −1, when the output grating 30 has a binary rectangular profile, a grating period d1 of 0.43 μm, a filling factor of 0.5, and a profile height h1 of 0.25 μm. In case of FIG. 8b, the respective out-coupling efficiency is only 1% by using the same output grating 30.

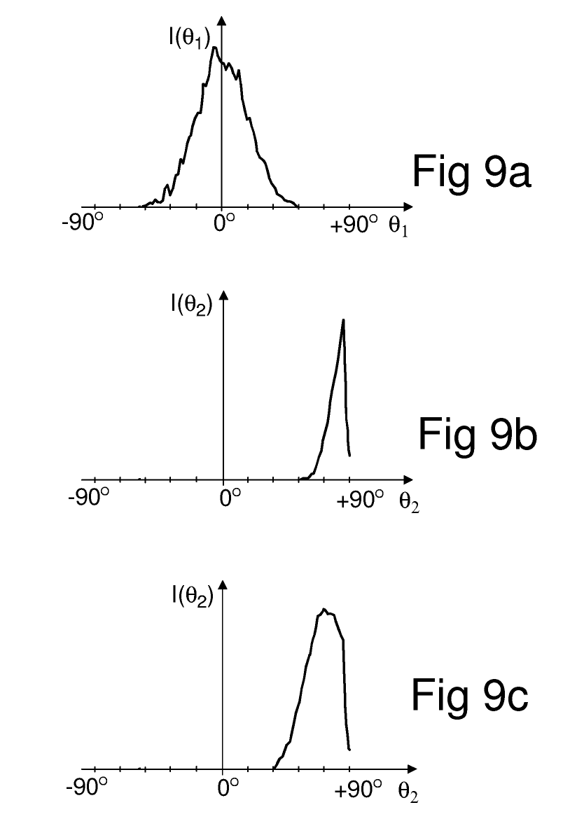

FIG. 9a shows the intensity distribution of a slightly collimated input beam B0 emitted by a light source 50.

Referring to FIG. 9b, it is assumed that the beam of FIG. 9a is coupled into a substrate through a smooth input face 11, as shown e.g. in FIG. 6. The input face 11 represents an air-polycarbonate interface, the angular intensity distribution of the beam B0 is expressed by eq. (1) having n=10, and the wavelength is 630 nm. FIG. 9b shows the angular intensity distribution of light B1 impinging on the out-coupling grating 30. It may be noticed that the peak of the angular intensity distribution is still approximately at an angle θ₂ of 85 degrees although the distribution is broader than in case of FIG. 8b. The position of the peak depends slightly on the ratio of the length of the out-coupling grating 30 to the thickness of the substrate 10.

Referring to FIG. 9c, it is assumed that the beam of FIG. 9a is coupled into a substrate through a binary input grating 12 having a period d1 of 1 μm, a filling factor of 0.5, and a profile height h1 of 0.5 μm. The input face 11 represents an air-polycarbonate interface, the angular intensity distribution of the beam B0 is expressed by eq. (1) having n=10, and the wavelength is 630 nm. FIG. 9c shows the angular intensity distribution of light B1 impinging on the out-coupling grating 30. It may be noticed that the peak of the angular intensity distribution is approximately at an angle θ₂ of 73 degrees, and the angular intensity distribution has a considerable value still at an angle 53 degrees.

The input grating 12 or the prisms 8a, 8b may be adapted to direct the light of the in-coupled beam B1, B1a, B1b such that an angle between the average direction of light impinging on the out-coupling grating 30 and the normal N2 is smaller than 70 degrees, in particular smaller than 60 degrees.

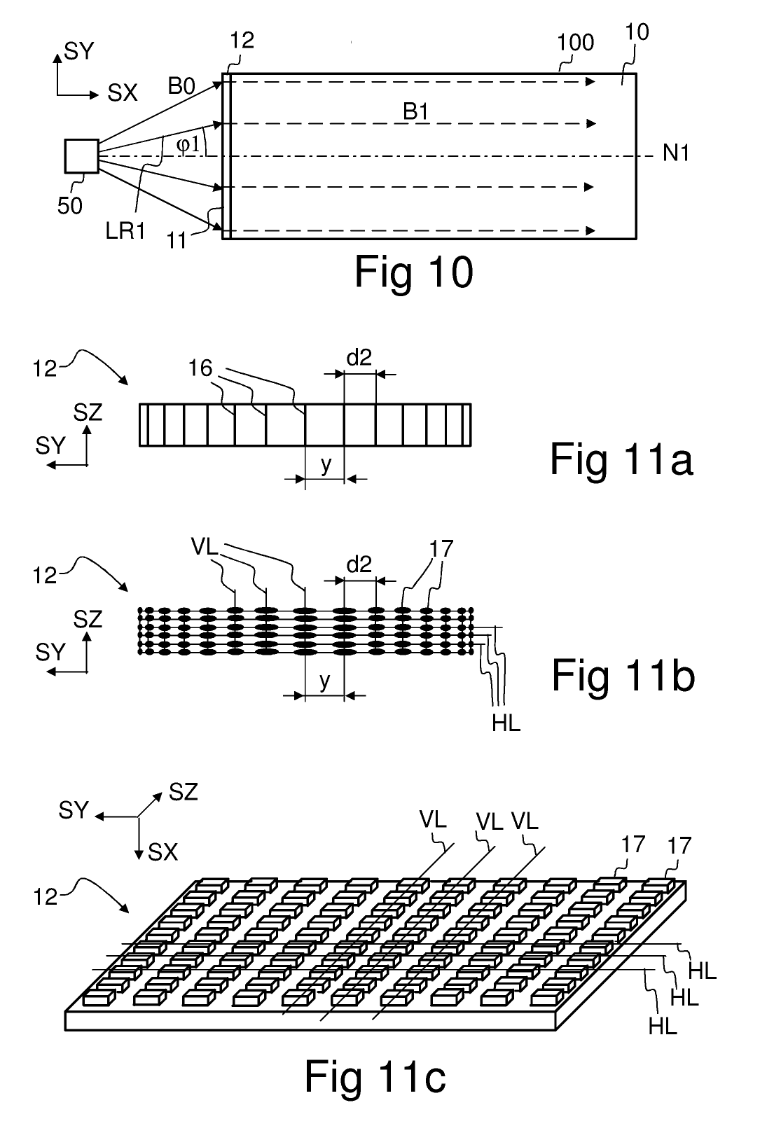

Referring to FIG. 10, the input grating 12 may also have diffractive features to diffract the input beam in the horizontal direction. (φ1 denotes a horizontal angle between a light ray LR1 and the surface normal N1.

Referring to FIG. 11a, the input grating 12 may comprise a plurality of substantially linear diffractive microscopic ridges 16 or grooves which are oriented in the vertical direction SZ to diffract light in the horizontal direction SY. The vertical ridges 16 may have a grating period d2. The vertical ridges 16 may be adapted to collimate the in-coupled beam B1 in the horizontal direction, i.e. the ridges 16 may act as a diffractive collimator. The ridges 16 may have a position-dependent grating period d2, i.e. a variable line density as a function of the horizontal distance y from the light source 50. The collimation may require a relatively high accuracy for positioning the light source 50 with respect to the input face 11.

Alternatively, the input grating 12 may comprise a plurality of substantially linear diffractive ridges 15 (FIG. 4) or grooves which are oriented in the horizontal direction SY to diffract light in the vertical direction SZ. The horizontal ridges 15 or grooves may have a grating period d1 (FIG. 4).

FIG. 11b shows a crossed grating. The input grating 12 may comprise a plurality of diffractive features 17, which are adapted to diffract light simultaneously in the vertical direction SZ and the horizontal direction SY. The diffractive features may be e.g. rectangular or oval microscopic studs (FIG. 11b). The diffractive features 17 are arranged along substantially vertical lines VL in order to diffract light in the horizontal direction SY and also along substantially horizontal lines HL in order to diffract light in the vertical direction SZ. The vertical lines VL are substantially parallel to the vertical direction SZ, and the horizontal lines HL are substantially parallel to the horizontal direction SY. The distance between the horizontal lines HL is equal to the grating period d1, and the distance between the vertical lines VL is equal to a grating period d2. Thus, the horizontal lines HL are arranged such that the input grating 12 has a first grating period d1 for diffraction in the vertical direction, and the vertical lines VL are arranged such that the input grating 12 has a second grating period d2 for diffraction in the horizontal direction.

The position of the vertical lines VL may correspond to a position-dependent grating period d2, i.e. a variable line density as a function of the horizontal distance y from the light source 50. The diffractive features 17 may be adapted to collimate the in-coupled beam B1 in the horizontal direction. In other words, the features 17 may act as a diffractive collimator. The collimation may require a relatively high accuracy for positioning the light source 50 with respect to the input face 11.

FIG. 11c shows a portion of a surface relief grating 12 according to FIG. 11b. The input grating 12 comprises a plurality of protrusions 17 which are arranged along a plurality of vertical lines VL and along a plurality of horizontal lines VL. The diffractive features 17 may be located at the intersections of the vertical lines VL and the horizontal lines. The protrusions 17 define a plurality of vertical and horizontal grooves between said protrusions 17. Alternatively, the input grating 12 may comprise a plurality of recesses which define a plurality of vertical and horizontal ridges between them.

The input grating 12 may be e.g. a slanted grating to diffract a majority of optical power substantially into one direction and diffraction order, e.g. into the diffraction order one.

The cutting and surface processing operations may be performed as a roll-to-roll process.

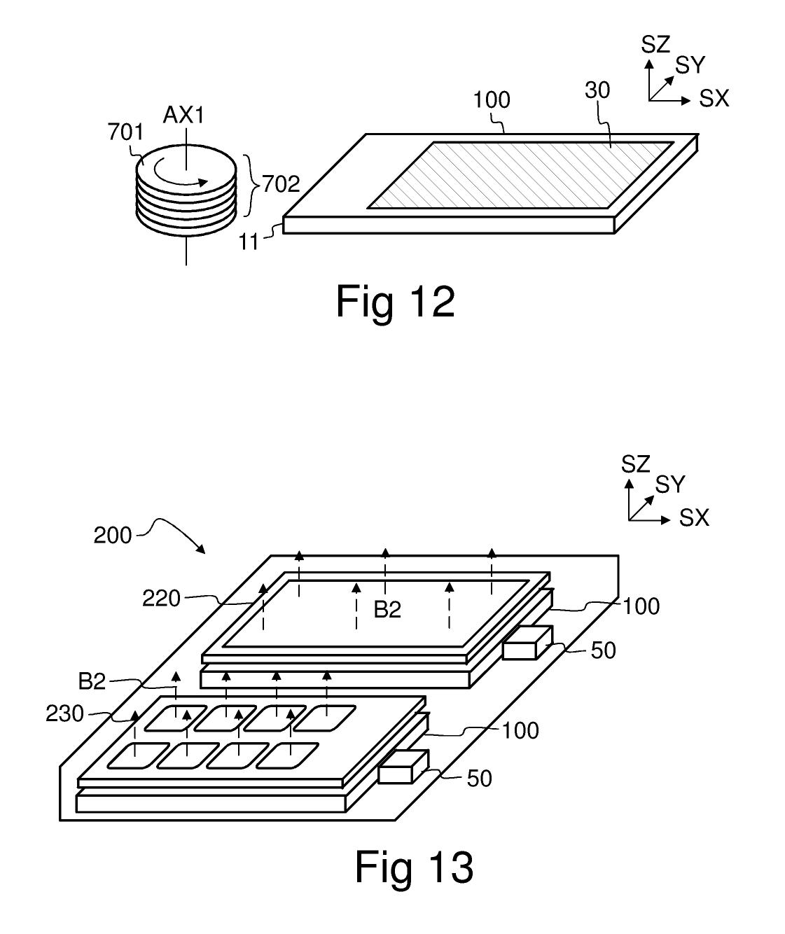

Referring to FIG. 12, the surface processing member 701 may also be a roll having a smooth surface or a grating pattern 702 on its surface.

The roll 701 may be pressed against the input face 11, and the input face 11 may be moved in the direction SY with respect to the roll 701 in order to emboss a grating pattern to said input face 11.

In an embodiment, the heated cutting member 901 also acts as the surface processing member 701.

The light guide 100 may be optimized to operate at a predetermined wavelength λ selected from the range of visible wavelengths 400-760 nm. The light guide 100 may be optimized to operate at the green wavelength 550 nm or at the whole range of visible wavelengths 400-760 nm.

The substantially planar surface 18 of the light guide 100 may have one or more out-coupling gratings 30.

FIG. 13 shows a device 200 comprising a keyset 230 and/or a display 200. One or more light distributing devices 100 may be used to provide front and/or back lighting to e.g. a liquid crystal (LCD) display 200 or a MEMS display (Micro-Electro-Mechanical System). One or more light distributing devices 100 may be used to provide lighting to or for a keyset 230. Partially transparent touch-sensitive elements, switches and or proximity sensors may be positioned on the top of the light guide 100, as shown in FIG. 13. The keyset 230 may be a keypad or a keyboard adapted to control the operation and the functions of the device 200.

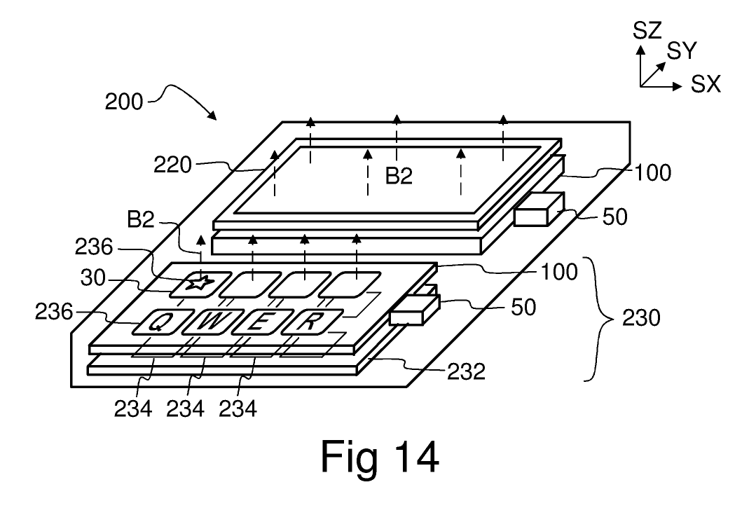

Referring to FIG. 14, the switches 234 of a key set 230 may also be located under the light guide 100. The light guide 100 may be at least partially flexible, and one or more touch-sensitive sensors or switches 234 may be positioned under the back side of a light guide 100. The switches 234 may also be proximity sensors positioned under the light guide 100. The switches 234 may be implemented on a switch pad 232 or on the back surface of the light guide 100. The light guide 100 may be an integrated part of an illuminated key set 230.

Illuminating of the key set 230 comprises illuminating of a pattern 236 associated with a function of said key-set 230. An out-coupling grating 30 may be adapted to illuminate a pattern 236, which is associated with a function of a switch 234. The key set 230 may comprise a plurality of illuminated patterns 236 and switches 234, wherein each pattern may be associated with a function of a switch 234. Thus, it is not necessary to illuminate the switches 234 itself, and the switches 234 may be opaque. The pattern 230 may be e.g. a star pattern, a letter “Q”, “W”, “E”, “R”, a number, or another character. The patterns 236 may be implemented e.g. by printing ink on the out-coupling gratings 30, or by superposing a patterned mask on the out-coupling gratings 30. Also the perimeter, i.e. the shape of the out-coupling gratings 30 may correspond to a pattern 236.

The device 200 may further comprise a battery, data processing and/or telecommunications module. The device 200 may be portable. The device 200 may comprise telecommunications capabilities. The device 200 may be e.g. a mobile phone, and/or a computer. Yet, the device 200 may be a personal digital assistant (PDA), a communicator, a navigation instrument, a digital camera, a video recording/playback device, an electronic wallet, an electronic ticket, an audio recording/playback device, a game device, a measuring instrument, and/or a controller for a machine.

For the person skilled in the art, it will be clear that modifications and variations of the devices and method according to the present invention are perceivable. All drawings are schematic. The particular embodiments described above with reference to the accompanying drawings are illustrative only and not meant to limit the scope of the invention, which is defined by the appended claims.

1-16. (canceled)

17. A method for processing an input face of a light guide, said light guide comprising an out-coupling grating implemented on a substantially planar surface of said light guide, said method comprising:
cutting a waveguiding sheet to form a cut face which is at an angle cc with respect to said substantially planar surface, said angle cc being in the range of 80 to 100 degrees,
heating said cut face,
and
pressing a surface processing member against said cut face in order to smooth or emboss said cut face.

18. The method according to claim 17 wherein the temperature of said cut face is at least temporarily during said pressing higher than the glass transition temperature of the material of said sheet.

19. The method according to claim 17 comprising heating said cut face by one of: a hot gas flow and radiation.

20. The method according to claim 17 comprising heating said surface processing member by using a heater.

21. The method according to claim 20 wherein the temperature of said surface processing member is kept lower than the maximum temperature of the material of said sheet.

22. The method according to claim 17 comprising forming a diffraction grating on said cut face, said grating being adapted to diffract more than 30% of light into diffraction order one or minus one.

23. The method according to claim 17 comprising forming at least two prisms on said cut face in order to direct in-coupled light.

24. The method according to claim 17 wherein said sheet is cut by using a hot cutting edge, and said cutting edge acts also as said surface processing member.

25. A method for distributing light by using a light guide comprising a substantially planar waveguiding substrate, an input face to couple light into said substrate, and an out-coupling grating to couple light out of said substrate, wherein an angle between said input face and said out-coupling grating is in the range of 80 to 100 degrees, said method comprising:
coupling an input beam into said substrate through said input face to form an in-coupled beam,
directing said in-coupled beam by using at least one of: an input grating and prisms, and
coupling light out of said substrate by an out-coupling grating.

26. The method according to claim 25 further comprising lighting at least one of: a key set and a display.

27. A device comprising:
a substantially planar waveguiding substrate,
an input face to couple light into said substrate, and
an out-coupling grating to couple light out of said substrate, wherein an angle between said input face and said out-coupling grating is in the range of 80 to 100 degrees, said input face comprising at least one of: a grating structure and prisms adapted to direct in-coupled light.

28. The device according to claim 27 wherein said input face comprises an embossed input grating to diffract light into a first predetermined direction.

29. The device according to claim 27 wherein said input face comprises at least two embossed macroscopic prisms to refract light into a first predetermined direction.

30. The device according to claim 27, further comprising:
a light source to provide an input beam, and a key set, wherein said input face is adapted to couple light of said input beam into said substrate to form an in-coupled beam propagating within said substrate, and said out-coupling grating is adapted to couple light of said in-coupled beam out of said substrate to form an output beam, said output beam being adapted to illuminate said key set, and said prisms comprising several inclined prism faces adapted to direct said in-coupled beam.

31. A device according to claim 30 wherein the surface of said input face being substantially smooth such that at least one of: light-scattering protrusions and recesses cover less than 5% of the area of said input face.
